(19) United States
(12) Patent Application Publication
(10) Pub. No.: US 2003/0173104 A1
(43) Pub. Date: Sep. 18, 2003

(54) Process for producing a cable, particularly for electrical power transmission or distribution, and cable produced therefrom

(76) Inventors: Gaia Dell'Anna, Milano (IT); Cristiana Scelza, Angellara di Vallo della Lucania (IT); Luca Catellani, Corsico (IT); Alberto Bareggi, Milano (IT); Enrico Albizzati, Lesa (IT)

Correspondence Address: FINNEGAN, HENDERSON, FARABOW, GARRETT & DUNNER, LLP, 1300 I STREET, NW, WASHINGTON, DC, 20005, US

(21) Appl. No.: 10/333,138

(22) PCT Filed: Jul. 13, 2001
(86) PCT No.: PCT/EP01/08118

(30) Foreign Application Priority Data
Aug. 7, 2000 (EP) 00116948.1

(51) Int. Cl. H01B 7/00

(52) U.S. Cl. 174/126.1; 264/176.1

(57) ABSTRACT

The present invention relates to a process for producing a cable, particularly for medium or high voltage electrical power transmission or distribution, said process comprising the step of making at least one coating of said cable from an oriented thermoplastic polymeric material, said thermoplastic polymeric material comprising a homopolymer of propylene or a copolymer of propylene and selected olefinic comonomer. In detail, this process comprises the steps of feeding at least one conductor of said cable to an extruding machine, extruding said at least one coating into a position radially external to said at least one conductor, orienting said at least one coating during said extrusion step. The present invention also relates to a cable, particularly for medium or high voltage electrical power transmission or distribution, provided with a coating of oriented thermoplastic polymeric material.

The present invention relates to a process for producing a cable, particularly for medium or high voltage electrical power transmission or distribution.

More particularly, the present invention relates to a process for producing a cable, preferably for medium or high voltage electrical power transmission or distribution, comprising the step of making at least one coating of said cable from an oriented thermoplastic polymeric material.

Furthermore, the present invention relates to a cable, particularly for medium or high voltage electrical power transmission or distribution, provided with a coating of oriented thermoplastic polymeric material.

The requirement for highly environmentally compatible products, produced from materials which do not damage the environment either during production or in use, and which can easily be recycled at the end of their service life, is particularly marked also in the field of power cables, telecommunications cables, data transmission cables and/or combined power and telecommunications cables. Therefore, in the following of the present description and in the claims, the term “conductor” denotes a conductor of the metallic type, of circular or sectoral configuration.

However, the use of environmentally compatible materials is subjected to the need of containing costs while providing a performance which is at least equivalent to, and preferably better than, that of the conventionally used materials.

In the field of medium or high voltage power transmission cables, the insulating coating which surrounds the conductor usually consists of a cross-linked polyolefin-based polymeric material, particularly cross-linked polyethylene (XLPE), or ethylene/propylene (EPR) or ethylene/propylene/diene (EPDM) elastomeric copolymers which are cross-linked too. The cross-linking, carried out on the production line immediately after the extrusion step, imparts a satisfactory mechanical performance to the material even when the latter is hot, in continuous use and in current overload conditions.

However, it is well known that cross-linked materials are not recyclable, and therefore both the production wastes and the cable coating material which has reached the end of its life have to be disposed of by incineration.

Moreover, the aforesaid cables are conventionally provided with an outer protective sheath generally consisting of polyvinyl chloride (PVC) which is difficult to separate by means of conventional methods (based on the difference of density in water, for example) from the cross-linked insulating material, particularly from cross-linked polyolefins containing mineral fillers (for example, ethylene/propylene rubbers). Furthermore, it is known that polyvinyl chloride cannot be disposed of by incineration, unless special and particularly costly combustion furnaces are used, since it develops highly toxic chloride products as a result of combustion.

There is, therefore, an awareness of the need, in the field of medium or high voltage power transmission cables, for coatings, particularly insulating coatings, consisting of basic polymeric materials which are recyclable and which, at the same time, can provide electrical and mechanical performances at least equal to those of the aforesaid cross-linked polymeric materials.

In the field of non-cross-linked polymeric materials for coating high voltage cables, the use of high-density polyethylene (HDPE), for example, is known. However, by comparison with XLPE, high-density polyethylene has the disadvantage of withstanding a lower operating temperature, both in current overload conditions and in normal operating conditions.

Patent application WO 96/23311 describes a low voltage, high current cable in which the insulating coating, the inner sheath and the outer sheath consist of the same non-cross-linked polymeric material, coloured black by the addition of carbon black. The use of the same material in the different layers makes it unnecessary to separate the aforesaid components in a recycling process. For a maximum operating temperature of 90° C., it is stated that it is possible to use heterophase thermoplastic elastomers consisting of a matrix of polypropylene in which an elastomeric phase consisting of EPR or EPDM copolymers is dispersed.

Patent application EP-A-527,589 describes a polymeric composition comprising: (a) 20-80% by weight of an amorphous polyolefin comprising propylene and/or butene-1 in a quantity of at least 50% by weight, and (b) 80-20% by weight of crystalline polypropylene. The composition is prepared by mechanical mixing of the amorphous polyolefin with the crystalline polypropylene. This composition has optimal flexibility when cold, while maintaining a high mechanical strength when hot, in the way typical of polypropylene, as a result of which it would appear ideal as an insulating material for cable as well as for other purposes.

European patent application EP-893,801, in the name of the present Applicant, describes a cable comprising a conductor and one or more coating layers, wherein at least one of said coating layers comprises as the basic non-cross-linked polymeric material a mixture comprising: (a) a crystalline propylene homopolymer or copolymer; and (b) an elastomeric copolymer of ethylene with at least one α-olefin having from 3 to 12 carbon atoms, and optionally with a diene; said copolymer (b) being characterized by a 200% tension set value (measured at 20° C. for 1 minute according to ASTM standard D 412) lower than 30%.

By using a crystalline propylene homopolymer or copolymer in a mixture with an elastomeric copolymer of ethylene having high elastic return properties without the use of cross-linking, it is possible, as indicated by the low values of tension set (in other words, of permanent deformation following the application of a given tensile force), to obtain a coating of the recyclable type having good mechanical properties (particularly elongation at break, tensile strength and modulus) and electrical properties (particularly in respect of water absorption).

European patent application EP-893,802 in the name of the present Applicant describes a cable comprising a conductor and one or more coating layers, in which at least one of said coating layers comprises as the non-cross-linked basic polymeric material a mixture comprising: (a) a crystalline propylene homopolymer or copolymer; and (b) a copolymer of ethylene with at least one α-olefin having from 4 to 12 carbon atoms, and optionally with a diene; said copolymer (b) being characterized by a density of between 0.90 and 0.86 g/cm³ and by a composition distribution index, defined as the percentage by weight of copolymer molecules having an α-olefin content within 50% of the average total molar content of α-olefin, of more than 45%.

By using a crystalline propylene homopolymer or copolymer in a mixture with a copolymer of ethylene with an α-olefin having a low density and high structural regularity, particularly a distribution of the α-olefin which is as uniform as possible, it is possible to produce a non-cross-linked, and therefore recyclable, coating which also has good mechanical properties (particularly elongation at break, tensile strength and modulus) and electrical properties. The aforesaid high structural regularity can be obtained, in particular, by copolymerization of the corresponding monomers in the presence of a “single-site” catalyst, for example a metallocenic catalyst.

GB-1,599,106 describes a process for producing an electrical cable provided with a coating, for insulation or protection from the external environment, made from a crystallizable polymeric material capable of improving the mechanical and chemical properties of the cable, particularly the resistance to chemically corrosive environments (for example, in the presence of particularly corrosive industrial fluids).

In greater detail, GB-1,599,106 describes a process for continuous production of an electrical cable, comprising the steps of: a) advancing the core of said cable, comprising at least one conductor; b) extruding around said core a tube of crystallizable polymeric material whose dimensions are greater than those of said core; c) cooling the extruded tube thus produced (preferably at a temperature below the glass transition temperature of said polymeric material) in such a way that it can be gripped and advanced at a given first speed by means of a first gripping and pulling member; d) reheating said tube to a temperature in the range between the aforesaid glass transition temperature and the melting point of said polymeric material; e) carrying out a stretching operation on said tube by means of a further gripping and pulling member operating at a second speed which is greater than said first speed; f) making the aforesaid tube collapse on to said cable core. This stretching operation causes the development of a shear force in the polymer which is capable of producing the crystalline orientation mentioned above.

This method can also comprise, after the stretching operation, a step of reheating (“annealing”) of the polymeric material to a temperature above the stretching temperature but below the melting point. Conveniently, the stretching operation can also be carried out in two or more separate steps by suitable reheating (“annealing”) steps.

U.S. Pat. No. 4,533,417 describes an electrical cable producing process of the type illustrated in GB-1,599,106, said process comprising, immediately before the stretching step described above, a step of maintaining the extruded tube thus formed at a temperature in the range between the glass transition temperature and the melting point of the polymeric material for a period sufficient to produce a substantial degree of crystallinity within said material before the material is subjected to said stretching operation.

This process is suitable for the production of insulated cables for use in a plurality of industrial applications, where dielectric strength in wet environments and/or resistance to chemical corrosion (resistance to solvents and corrosive industrial environments, for example oil wells) are particularly desired.

U.S. Pat. No. 4,451,306 describes a process of producing a cable comprising a core around which there are placed two extruded coatings, at least one of which is made from crystallizable polymeric material. In greater detail, this method, which can be used to orient one or both of the aforesaid coatings in a smaller space and with a smaller amount of equipment than the processes described above, comprises the steps of: a) extruding a first coating of crystallizable polymeric material with dimensions greater than those of said core, so that it is spaced apart from the latter; b) cooling said first coating to a temperature below the glass transition temperature of said material so that said first coating can be gripped and advanced at a first speed by a first gripping and pulling member; c) extruding a second coating of crystallizable polymeric material around and in contact with said first coating; d) cooling the whole assembly thus formed in order to allow it to be gripped and advanced, at a second speed greater than the first, by a further gripping and pulling member. The heat exchange between the aforesaid coatings and a suitable selection of the extrusion temperatures cause the decrease of the first coating yield strength, after the second extruder, to exceed the simultaneous increase of second coating yield strength, and cause both the coatings to be elongated together, thus orienting their polymeric material.

U.S. Pat. No. 5,006,292 relates to the production of a polyolefinic film usable as insulating coating of a cable, particularly a high voltage cable of the oil-impregnated paper type (Ultra High Voltage Oil-Filled Cable). The sheet of polymeric material produced by an extrusion operation is subjected to a stretching or rolling operation at a temperature of approximately 20° C.-50° C. below its melting point, thus generating a film of limited thickness (80-250 μm) whose initial particles are transformed, by the shear action produced by said stretching or rolling, into microfibrous particles oriented parallel to the orientation axis of the polymer matrix.

The prior art solutions relating to coatings for cables, with particular reference to insulating coatings for electrical cables, made from a recyclable polypropylene-based polymeric material, show a good mechanical performance, both when cold and when hot, in conditions of current overload or short circuit (and, in particular, good mechanical strength and flexibility), sometimes even better than those of cross-linked polyolefinic coatings. However, the Applicant has found that this mechanical performance is not always accompanied by electrical properties (such as dielectric strength and resistance to partial discharges) which can be considered satisfactory for medium or high voltage electrical cables, in other words for cables having insulating coatings of considerable thickness, generally not less than 2.5 mm.

Therefore, the Applicant has perceived the necessity of improving the electrical reliability of electrical cable coatings made from thermoplastic polymeric material, preferably based on polypropylene or copolymers thereof, particularly in the case of cables for the transmission or distribution of electrical power at medium or high voltage.

In fact the use of a non-cross-linked thermoplastic material, on the one hand, makes it possible to obtain a cable with high environmental compatibility which, as stated above, can be easily recycled at the end of its service life, and, on the other hand, permits a considerable simplification of the layout and operation of the production plant, since the installation of a line for the chemical or physical cross-linking of the polymeric material is not required.

Therefore, the Applicant considered that it would be possible to advantageously increase the electrical reliability (particularly the dielectric strength and the resistance to partial discharges) of the coating of a cable, particularly the insulating coating of a medium or high voltage cable, by imparting a suitable molecular orientation to the thermoplastic polymeric material of said coating.

For the sake of greater simplicity of description, in the following of the present description and in the claims, the term “molecular orientation” will be abbreviated to “orientation”.

As noted above, the orientation techniques described in the documents cited above require the use of a stretching operation, to be carried out on the coating material in a step following the extrusion step of the coating.

However, this technology, although applicable in the case of coatings of limited thickness, for example for cables for low voltage electrical power transmission or distribution, is not applicable when the aforesaid coatings have considerable thicknesses, for example in excess of 2.5 mm, which are the thicknesses typical of an insulating coating of a cable for medium or high voltage electrical power transmission or distribution.

In fact, in the case of particularly thick coatings, the stretching operation applied to said coatings would not be capable of ensuring a sufficient and uniformly distributed orientation throughout the thicknesses of the coatings. Consequently, an orientation produced in this way would not be sufficient to produce a significant increase in the electrical properties of said coatings. This means, therefore, that the technologies of the prior art described above would not be capable of ensuring, for such a thickness, the desired electrical reliability in normal operating conditions, and, even more so, in conditions of current overload.

Furthermore, the Applicant perceives that the orientation of a coating of considerable thickness by means of the prior art techniques would not be feasible in an industrial context since it would require a very low stretching speed in order to impart a sufficient orientation throughout the thickness of said coating. This would then entail some disadvantages such as the necessity of providing a particularly long stretching section, with negative effects on the overall dimensions of the production line, and of operating with particularly long production times. Implementation in this form, therefore, could not be proposed on an industrial scale. Furthermore, since in cables for medium or high voltage electrical power transmission or distribution the insulating layer is usually co-extruded with the inner and outer semiconductive layers, any device capable of exerting a stretching action on the insulating layer after the extrusion step would also act on the semiconductive layers, thus adversely affecting the mutual adhesion between them and between said layers and the conductor element, as well as the quality of the interfaces between the layers.

The Applicant has found that it is possible to produce a cable, particularly for medium or high voltage electrical power transmission or distribution, by using as coating material a thermoplastic homopolymer or copolymer of propylene, to which an orientation is imparted during the extrusion step of the material in such a way as to improve its electrical performance, particularly its dielectric strength. The cable thus produced has both optimal mechanical properties and high electrical reliability.

More particularly, the Applicant has found that a sufficient and uniform orientation of the material, particularly of the insulating coating of a cable for medium or high voltage electrical power transmission or distribution, such that its electrical performance is significantly improved, can be obtained during the extrusion step of said material by controlling the temperature of the melt leaving the extruder head in such a way that said temperature is in the range from the melting point of the material to a temperature not more than 20° C. above said melting point. In particular, the Applicant has found that this orientation step, carried out during the extrusion step according to the thermal conditions stated above, makes it possible to impart to said insulating coating a dielectric strength of at least 30 kV/mm.

Therefore, in a first aspect the present invention relates to a process for producing a cable for medium or high voltage electrical power transmission or distribution, said cable comprising at least one conductor and at least one coating made from thermoplastic polymeric material comprising a homopolymer of polypropylene, or a copolymer of propylene and an olefinic comonomer, said olefinic comonomer being chosen from ethylene and α-olefins other than propylene, said process comprising the steps of:

feeding said at least one conductor (2) to an extruding machine;

extruding said at least one coating (3, 4, 5) in a position radially external to said at least one conductor (2),

characterized in that said extrusion step comprises the step of orienting said at least one coating (3, 4, 5).

In the process according to the present invention, the step of orientation comprises the step of setting the temperature of the material forming said at least one coating, at the outlet of said extruding machine, at a level exceeding the melting point of said material by not more than 20° C., preferably by not more than 15° C., and more preferably by not more than 10° C.

In the process according to the present invention, after the extrusion and cooling steps, said material forming said at least one coating has an intensity ratio between the diffractometric peaks with indices 110 and 040 of not more than 1.

In a second aspect, the present invention relates to a cable comprising at least one conductor and at least one extruded coating made from a thermoplastic polymeric material, said material comprising a homopolymer of propylene or a copolymer of propylene with an olefinic comonomer chosen from ethylene and α-olefins other than propylene, said at least one coating having a thickness of not less than 2.5 mm, characterized in that said at least one coating has an intensity ratio between the diffractometric peaks with indices 110 and 040 of not more than 1.

According to the present invention, said at least one coating of said cable has a dielectric strength of more than 30 kV/mm.

Preferably, said at least one coating of said cable is the insulating coating of said cable.

In a third aspect, the present invention relates to a method for increasing the dielectric strength of at least one coating placed in a position radially external to at least one conductor of a cable, at least one coating being made from a thermoplastic polymeric material comprising a homopolymer of propylene, or a copolymer of propylene and an olefinic comonomer chosen from ethylene and α-olefins other than propylene, characterized in that said thermoplastic polymeric material is oriented during the extrusion step of said at least one coating.

Further details will be illustrated by the following detailed description, with reference to the attached drawings, provided solely for illustrative purposes and without restrictive intent, in which:

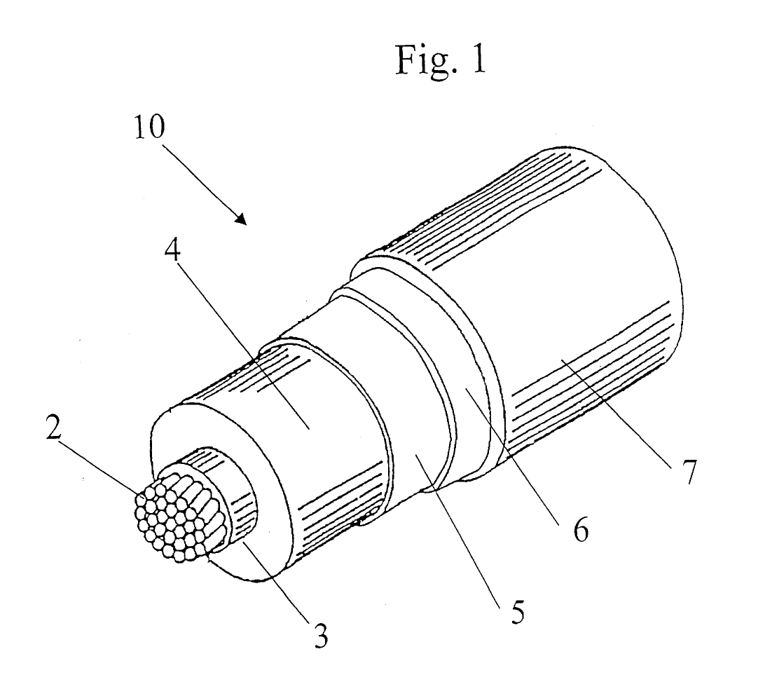

FIG. 1 is a perspective view of an electrical cable, particularly suitable for medium or high voltage electrical power transmission or distribution, and

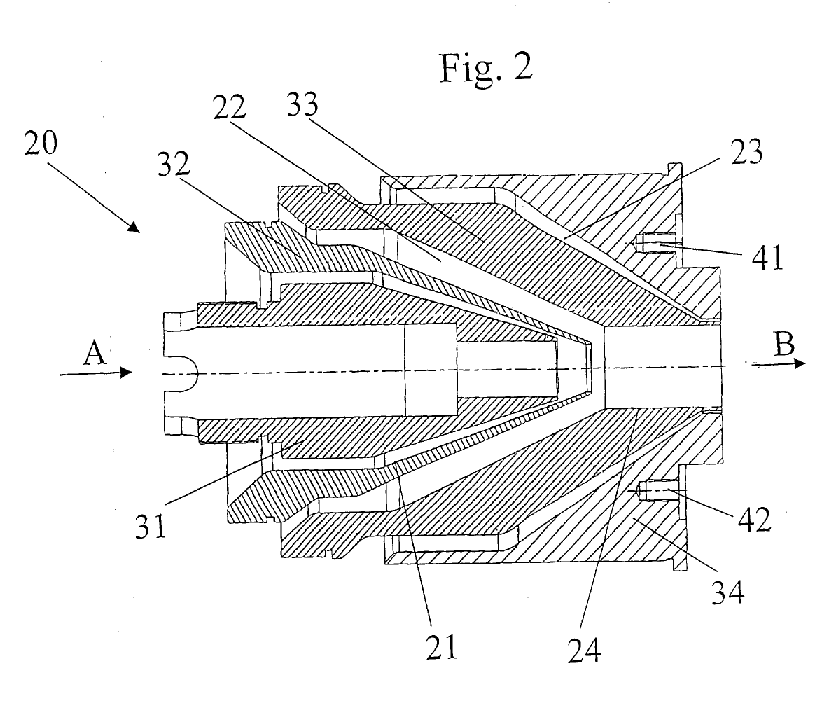

FIG. 2 is a view in longitudinal section of a detail of the apparatus for extruding said cable.

In detail, in FIG. 1 the cable 10 comprises: a conductor 2, an inner layer with semiconductive properties 3, an intermediate layer with insulating properties 4, an outer layer with semiconductive properties 5, a metallic screen 6 and an outer sheath 7.

For the purposes of the present description and the following claims, the general term “coating of a cable” denotes any coating of thermoplastic polymeric material possessed by said cable.

Therefore, with reference to the aforesaid FIG. 1, the general term “coating” refers equally to the insulating layer 4 and to the semiconductive layers 3, 5.

The conductor 2 generally consists of one or more metal wires, preferably made from copper or aluminium, stranded together by conventional techniques. If necessary, said conductor may be of the known sectoral type.

A metallic screen 6, generally consisting of metal wires (for example, steel or copper wires), a continuous tube (made from aluminium, lead or copper), or a metal strip wound spirally and welded or sealed with a suitable adhesive material in order to ensure adequate hermeticity, is usually positioned around the outer semiconductive layer 5. Generally, said screen is produced by a wire or strip armouring machine of a known type.

This screen 6 is then covered with a sheath 7 consisting of a thermoplastic material, for example non-cross-linked polyethylene (PE) or, preferably, a homopolymer or copolymer of propylene as defined above.

The cable 10 can also be provided with a protective structure (not shown) placed in a position radially external to said sheath 7 and having the primary function of mechanically protecting the cable from impact and/or compression. This protective structure can be, for example, a metallic armour or an expanded polymeric coating as described in patent application WO 98/52197 in the name of the present Applicant.

According to the present invention, at least one layer of polymeric coating chosen from the insulating layer 4 and the semiconductive layers 3, 5 is produced from a polymeric material based on a homopolymer of propylene or a copolymer of propylene with an olefinic comonomer chosen from ethylene and α-olefins other than propylene, as defined in greater detail below, subjected to a step of orientation directly during the extrusion operation, as illustrated more clearly in the following of the present description.

Preferably, this coating based on a thermoplastic polymeric material comprises a homopolymer of propylene or a copolymer of propylene with an olefinic comonomer chosen from ethylene and α-olefins other than propylene, said homopolymer or copolymer having a melting point above or equal to 140° C. and a melting enthalpy from 30 to 100 J/g.

Preferably, the homopolymer or copolymer of propylene has a melting temperature in the range from 145 to 170° C.

Preferably, the homopolymer or copolymer of propylene has a melting enthalpy in the range from 30 to 85 J/g.

Preferably, the homopolymer or copolymer of propylene has an elastic bending modulus, measured according to the ASTM D790 standard at environmental temperature, in the range from 30 to 1400 MPa, preferably from 60 to 1000 MPa.

Preferably, the homopolymer or copolymer of propylene has a melt flow index (MFI), measured at 230° C. with a load of 21.6 N according to the ASTM D1238/L standard, in the range from 0.01 to 10.0 dg/min, preferably from 0.1 to 5.0 dg/min, and more preferably from 0.2 to 3.0 dg/min.

It should be noted that, as the viscosity of the used polymeric material increases, and therefore as its Melt Flow Index decreases, the orientation which can be imparted to said material also increases.

If a copolymer of propylene with an olefinic comonomer is used, the latter is preferably present in a proportion less than or equal to 15 mole %, and more preferably less than or equal to 10 mole %. The olefinic comonomer is, in particular, ethylene or an (α-olefin having formula CH₂═CH—R, where R is an alkyl, linear or branched, having from 2 to 10 carbon atoms, chosen, for example, from: 1-butene, 1-pentene, 4-methyl-1-pentene, 1-hexene, 1-octene, 1-decene, 1-dodecene, and the like, or combinations thereof.

Propylene/ethylene copolymers are particularly preferred.

Preferably, said thermoplastic material is chosen from:

(a) a homopolymer of propylene or a copolymer of propylene with an olefinic comonomer chosen from ethylene and α-olefins other than propylene, having an elastic bending modulus generally in the range from 30 to 900 MPa, and preferably from 50 to 400 MPa;

(b) a heterophasic copolymer comprising a polypropylene-based thermoplastic phase and an elastomeric phase based on ethylene copolymerized with an (α-olefin, preferably with propylene, in which the elastomeric phase is present in a quantity of at least 45% by weight with respect to the total weight of the heterophasic copolymer.

The homopolymers or copolymers belonging to class (a) have a monophasic microscopic structure, i.e. substantially free of heterogeneous phases dispersed in molecular domains having dimensions of more than one micron. This is because these materials do not show the optical phenomena typical of heterophasic polymeric materials, and in particular are characterized by a better transparency and by a reduced “whitening” of the material as a result of localized mechanical stresses (commonly known as “stress whitening”).

Within class (a) as described above, particular preference is given to a homopolymer of propylene or a copolymer of propylene with an olefinic comonomer chosen from ethylene and α-olefins other than propylene, said homopolymer or copolymer having:

a melting point from 140 to 170° C., preferably from 155 to 165° C.;

a melting enthalpy from 30 to 80 J/g;

a fraction soluble in boiling diethyl ether of 12% by weight, preferably from 1 to 10% by weight, having a melting enthalpy less than or equal to 4 J/g, and preferably less than or equal to 2 J/g;

a fraction soluble in boiling n-heptane of 15 to 60% by weight, preferably from 20 to 50% by weight, having a melting enthalpy from 10 to 40 J/g, and preferably from 15 to 30 J/g; and

a fraction insoluble in boiling n-heptane of 40 to 85% by weight, preferably from 50 to 80% by weight, having a melting enthalpy greater than or equal to 45 J/g, preferably from 50 to 95 J/g.

Further details of these materials and their use for cable coatings are reported in European patent application No. 99122840 filed on 17.11.1999 in the name of the Applicant, and incorporated herein by reference.

Heterophasic copolymers belonging to class (b) are thermoplastic elastomers produced by sequential copolymerization of: (i) propylene, possibly containing smaller quantities of at least one olefinic comonomer chosen from ethylene and (α-olefins other than propylene; and then of: (ii) a mixture of ethylene with an (α-olefin, particularly propylene, and possibly with smaller proportions of a diene. This class of products is also commonly known by the term “thermoplastic reactor elastomers”.

Within class (b) described above, particular preference is given to a heterophasic copolymer in which the elastomeric phase consists of an elastomeric copolymer of ethylene and propylene which comprises from 15 to 50% ethylene by weight and from 50 to 85% propylene by weight, with respect to the weight of the elastomeric phase. Further details referring to these materials and their use as cable coatings are given in Patent Application WO 00/41187 in the name of the Applicant, incorporated herein by reference.

Products of class (a) are available on the market, for example under the trade mark Rexflex® held by the Huntsman Polymer Corp..

Products of class (b) are available on the market, for example under the trade mark Hifax® held by Montell.

Alternatively, it is possible to use, as the base thermoplastic material, a homopolymer or copolymer of propylene as defined above in a mechanical mixture with a polymer having low crystallinity, generally with a melting enthalpy of less than 30 J/g, which has the primary function of increasing the flexibility of the material. The amount of low-crystallinity polymer is generally less than 70% by weight, preferably in the range from 60 to 20% by weight, with respect to the total weight of the thermoplastic material.

Preferably, the low-crystallinity polymer is a copolymer of ethylene with an α-olefin having from 3 to 12 carbon atoms, and possibly with a diene. Preferably, the α-olefin is chosen from: propylene, 1-hexene and 1-octene. If a dienic comonomer is present, it generally has from 4 to 20 carbon atoms, and is preferably chosen from: conjugate or non-conjugate linear diolefins, for example 1,3-butadiene, 1,4-hexadiene, or 1,6-octadiene; monocyclic or polycyclic dienes, for example 1,4-cyclohexadiene, 5-ethylidene-2-norbornene, 5-methylene-2-norbornene, 5-vinyl-2-norbornene, and the like.

Among the copolymers of ethylene, particular preference is given to:

(i) copolymers having the following monomeric composition: 35-90 mole % of ethylene; 10-65 mole % of α-olefin, preferably propylene; 0-10 mole % of a diene, preferably 1,4-hexadiene or 5-ethylidene-2-norbornene (EPR and EPDM rubbers belong to this class);

(ii) copolymers having the following monomeric composition: 75-97 mole %, preferably 90-95 mole %, of ethylene; 3-25 mole %, preferably 5-10 mole %, of α-olefin; 0-5 mole 90, preferably 0-2 mole %, of a diene (for example ultra-low density polyethylene (ULDPE) such as the Engage® products made by DuPont-Dow Elastomers).

To make a coating layer of a cable for medium or high voltage electrical power transmission or distribution, other conventional components, for example antioxidants, processing adjuvants, lubricants, pigments, water-tree retardants, voltage stabilizers, nucleating agents and the like, can be added to the basic polymeric material as defined above.

Examples of conventional antioxidants suitable for this purpose are distearylthio-propionate and pentaerythryl-tetrakis [3-(3,5-di-terbutyl-4-hydroxyphenyl)propionate] and the like, or mixtures thereof.

Examples of processing adjuvants which can be added to the polymeric base are calcium stearate, zinc stearate, stearic acid, paraffin wax, and the like, or mixtures thereof.

As mentioned above, the coatings made from polymeric material oriented in accordance with the process according to the present invention can be also used for making at least one semiconductive layer of a cable for medium or high voltage electrical power transmission or distribution.

Therefore, in such a case a conductive filler, particularly carbon black, is generally dispersed within the polymeric material, in an amount such that semiconductive features are imparted to said material (in other words, so that a resistivity of less than 5 Ohm*m is obtained at environmental temperature) . Said amount of conductive filler is generally in the range from 5% to 80% by weight, preferably from 10% to 50% by weight, with respect to the total weight of the polymeric material.

The addition of said fillers does not substantially degrade the mechanical properties of the coating, said properties being maintained well above the values considered acceptable for semiconductive layers.

The possibility of using the same type of polymeric material for the insulating layer and for the inner and outer semiconductive layers is particularly advantageous in the production of medium or high voltage cables since it provides an optimal adhesion between the adjacent layers, thus improving the electrical behaviour, particularly at the interface between the insulating layer and the inner semiconductive layer where the electrical field is stronger and, consequently, the risk of partial discharges is markedly higher.

In the context of the present invention, the term “medium voltage” denotes a voltage in the range from 1 to 35 kV, while “high voltage” denotes voltages higher than 35 kV.

Although the present description is primarily focused on the making of cables for medium or high voltage electrical power transmission or distribution, the orientation process according to the present invention can be used, in general, for the production of any thermoplastic polymeric coating for electrical devices, for cables of different types (for example, low voltage cables, cables for telecommunications or data transmission, and combined power and telecommunications cables), or for accessories used in the production of electrical power lines, such as terminals or joints.

As regards the process of producing a cable according to the present invention, the principal steps characterizing the aforesaid process are described hereinbelow with reference to the case in which it is required to make a single-core (unipolar) cable of the type illustrated in FIG. 1.

An electrical conductor 2 is unwound from a feed reel by any known method, for example by means of a pulling capstan designed to feed said conductor in a continuous and regular way to an extruding machine. This is because it is desirable for the pulling action to be constant in time so that the conductor can advance at a predetermined speed such that uniform extrusion of the coating layers of said cable is ensured.

Preferably, the conductor is guided into an extruding machine with a triple extrusion head, said apparatus comprising three separate extruders opening into a common extrusion head (the triple head mentioned above) in such a way that the inner semiconductive layer 3, the insulating layer 4 and the outer semiconductive layer 5 are co-extruded onto the conductor element 2.

In detail, FIG. 2 shows a triple extrusion head 20 of a known extruding machine, said triple head 20 comprising a male die 31, a first intermediate die 32, a second intermediate die 33 and a female die 34. Said dies are positioned in the aforesaid sequence, superimposed concentrically on each other in the radially outward direction from the axis of the conductor element.

More particularly, the arrow A indicates the direction of advance of the conductor element 2, the inner semiconductive layer 3 being extruded, through the duct 21 formed between the male die 31 and the first intermediate die 32, in a position radially external to the conductor element. The insulating layer 4 is extruded in a position-radially external to the inner semiconductive layer 3 through the duct 22 formed between the first intermediate die 32 and the second intermediate die 33. Finally, the outer semiconductive layer 5 is extruded in a position radially external to the insulating layer 4 through the duct 23 formed between the second intermediate die 33 and the female die 34. The arrow B indicates the direction of output of the assembly consisting of the conductor 2, the inner semiconductive layer 3, the insulating layer 4 and the outer semiconductive layer 5, formed in this way, of the cable 10 shown in FIG. 1. FIG. 2 also shows the mounting/dismounting holes 41, 42 of the extrusion head 20.

Therefore, while the conductor element 2 is being unwound, the polymeric composition used in the various coating layers described above is fed separately to the input of each extruder in a known way, for example by means of three separate hoppers.

If necessary, each polymeric composition can undergo a step of pre-mixing of the polymeric base with other components (fillers, additives, or other), said pre-mixing being carried out in an apparatus located before the extrusion process, such as, for example, an internal mixer of the tangential rotor type (Banbury), or of the interpenetrating rotor type, or in a continuous mixer of the Ko-Kneader type (Buss) or of the co-rotating or contra-rotating twin screw type.

Each polymeric composition is generally fed to the corresponding extruder in the form of granules and brought to a plasticized condition, in other words to the melted state, by the application of heat (by means of the outer cylinder of the extruder) and the mechanical action provided by a screw which processes the polymeric material and pushes it into the corresponding extrusion duct and towards the die outlet of each duct to form the coating layer.

According to the present invention, one or more of the aforesaid coatings is subjected to a step of orientation of the basic thermoplastic polymeric material of the coating directly during the extrusion of said material.

In greater detail, this orientation step is carried out by adjusting the thermal profile of the extruder in such a way that the melted material, as it leaves the extruder head, is at a temperature (T₁) in the range between the melting point of the polymeric material (T_{f}) and a temperature (T₂) exceeding said melting point of not more than 20° C. (in other words, T_{f}<T₁≦T₂, where T₂=T_{f}+20° C.). Therefore, in order to carry out the extrusion operation, it is necessary for the material to be in the melted state. However, in order that it can be suitably oriented, said material should be brought to a temperature slightly higher than its melting point. Preferably, this temperature exceeds the melting point of not more than 20° C., more preferably of not more than 15° C., and even more preferably of not more than 10° C.

For the purposes of the present description and the following claims, the term “melting point” denotes the second melting point.

The second melting point is generally determined by a differential scanning calorimetric analysis (DSC). The material is completely melted and cooled to complete solidification, and then re-heated to complete melting in order to erase the “thermal history” of the material. The second melting point is measured during this second heating.

According to the present invention, the aforesaid differential scanning calorimetric analysis was carried out by means of a Mettler apparatus, with a scanning rate of 10° C./min. (instrument head: DSC 30 type; microprocessor: PC 11 type; software: Mettler Graphware TA72AT.1).

According to the present invention, as demonstrated more clearly by the following examples, the die for the extrusion of the oriented coating is preferably provided with an extension positioned coaxially with respect to the conductor element of the cable.

Preferably, this extension has a length equal to at least 4 times the thickness of the layer of insulating material to be deposited on the conductor element. More preferably, this extension has a length of at least 20 mm.

The assembly consisting of the conductor, the inner semiconductive layer, the insulating layer and the outer semiconductive layer, known in the art as “cable core”, is generally subjected to a cooling cycle as it leaves the extruder. Preferably, this cooling is carried out by moving the cable within a cooling channel in which a suitable fluid, typically water at environmental temperature, is used.

Preferably, this cooling operation is carried out as near as possible to the extrusion head, in such a way as to “lock” the orientation of the material obtained during the extrusion step.

Preferably, this production line has a multiple passage system for the cable within said cooling channel, both in order to ensure a more effective cooling cycle of the cable, and to provide the processing line with a buffer sufficient to ensure that the advancing speed of the cable is constant and equal to the predetermined value.

After this cooling step, the cable is generally subjected to drying, for example by means of air blowers.

As has been stated, if a cable of the type illustrated in FIG. 1 is to be produced, the core produced in this way is stored on an intermediate collecting reel, since the metallic screen 6, located in a position radially external to said core, is applied, by known methods, on a different line of the production plant.

For example, said screen is produced by means of a “tape screening machine” which deposits thin strips of copper (having a thickness of 0.1-0.2 mm for example) in a spiral way, by means of suitable rotary heads, preferably providing an overlap between the turns of said strips equal to approximately 33% of their surface area.

Alternatively, said screen consists of a plurality of copper wires (having a diameter of 1 mm for example) unwound from reels positioned on suitable rotating cages and applied spirally to said core.

This cable is then generally completed with an outer polymeric sheath positioned on top of said screen and produced, for example, by extrusion.

The cable is then wound onto a final collecting reel and sent to a storage department.

If a multiple-core cable is to be produced, the process described up to this point for a single-core cable can be suitably modified according to the information provided and the technical knowledge possessed by a person with average skill in the art.

Some illustrative examples are hereinbelow provided for further describing the invention.

### EXAMPLE 1

Test specimens of Rexflex® WL 105, a polypropylene homopolymer produced by Huntsman Polymer Corporation, were prepared in accordance with the EFI method (Norwegian Electric Power Research Institute), described in the publication “The EFT Test Method for Accelerated Growth of Water Trees” presented at the “1990 IEEE International Symposium on Electrical Insulation” held at Toronto, Canada, on Jun. 3-6, 1990.

The objective of this test method was to prepare, in a rapid and simple way, a test specimen capable of simulating the structure of a cable.

In fact, this test method provides an approximate solution, as demonstrated by the fact that the values of dielectric strength measured on the insulating coating of a real cable are generally considerably lower than the values obtainable from the same material in the form of a flat test specimen. The reasons for these differences, which are not fully known, are considered to be related to the greater probability of finding defects (for example voids, protrusions, metallic particles and contaminants) formed in the insulating layer of the cable during the extrusion process, since the cable has an insulation volume much greater than that of the test specimen.

Therefore, according to the aforesaid EFI method, the cable was simulated by providing multiple-layered cup-shaped test specimens, in which the material forming the insulating coating of the cable was enclosed in a “sandwich” form between two layers of semiconductive material representing, respectively, the inner and outer semiconductive layers of said cable.

In greater detail, the initial material, namely Rexflex® WL 105, in granular form, was subjected to a pre-moulding operation at 190° C. to produce a sheet with a thickness of approximately 1 cm.

Discs with a diameter of 5 cm (and a thickness of 1 cm) were formed from said sheet by punching, and were placed in appropriate cup-shaped moulds and heated to 166° C. for a period of 45 minutes. This temperature of 166° C. is a temperature close to the melting point of Rexflex® WL 105, said melting point being equal to 159° C.

At the end of this period, said discs were subjected to a pressure moulding operation, for example by using a hydraulic press capable of developing a pressure of 90 t for a period of 30 minutes. Thus the cup-shaped test specimens produced in this way had a base wall thickness in the range from 0.40 mm to 0.45 mm. At the end of the moulding step, said test specimens were cooled to environmental temperature.

In order to simulate the structure of a cable, as mentioned above, the base wall of each test specimen was painted with a graphite-based semiconductive varnish to permit the application of high electrical gradients. In detail, this varnish was applied both to the inner surface of the base wall of the test specimen (in other words, to the surface of the base wall facing the interior of the cup) and to the outer surface of the base wall of the test specimen (in other words, to the surface of the base wall which formed the base on which the cup rested), in such a way as to form an inner semiconductive layer and an outer semiconductive layer enclosing the base wall of the cup, in other words the insulating layer of the cable simulated in this way.

The test specimens formed in this way were tested electrically by introducing a dielectric oil (silicone oil) into the cavity of each cup-shaped test specimen and immersing in said oil a high-voltage electrode, in the form of a metal disc connected to a high-voltage transformer. Each test specimen was then placed on a metal plate capable of providing a better electrical earth contact. The outer semiconductive layer acted as an earth electrode.

Said test specimens were subjected to a measurement of dielectric strength by applying to the aforesaid high-voltage electrode a voltage gradient (in alternating current at 50 Hz) of 2 kV/s (initial value of 0 kV) until perforation of the insulating coating occurred.

The values of dielectric strength (expressed in kV/mm) were calculated statistically, in other words each value of dielectric strength shown in Table 1 represents a mean value found by the statistical processing of the values found from 10 test specimens.

Additionally, in order to determine the crystalline orientation of the material, the EFI test specimens of Rexflex® WL 105 were subjected to X-ray diffractometric measurements using a Philips automatic diffractometer for powders with a Nickel filter, making use of an analysis radiation of the CuKα type.

For example, in the case of isotactic polypropylene this orientation is measured as the ratio between the intensity of the peak with the index 110 and the intensity of the peak with the index 040, the intensities of said peaks being found by calculating their areas and subtracting the contribution of the amorphous parts from said areas. This measurement of diffraction was carried out with CuKα radiation in an interval of the diffraction angle 2θ in the range from 10° to 30°.

However, for the purposes of the present description and the following claims, the orientation of a thermoplastic polymeric material based on a propylene homopolymer or copolymer with an olefinic comonomer chosen from ethylene and α-olefins other than propylene is defined as the ratio between the intensity of the peak with the index 110 and the intensity of the peak with the index 040.

The Applicant has found that, for test specimens made from thermoplastic polymeric material based on a completely disoriented propylene homopolymer or copolymer, said intensity ratio, as defined above, is approximately equal to 3 and tends to decrease as the orientation of said material increases. This means, therefore, that as the orientation of this material becomes greater, said intensity ratio becomes smaller.

Therefore, in accordance with the process according to the present invention, a material having the aforesaid intensity ratio ≦1 is defined as completely oriented and a material having this intensity ratio equal to at least 3 is defined as completely disoriented.

It should be emphasized that this ratio also depends on the orientation of the crystallographic axes of the material, and therefore on the way in which the specimen is positioned on the diffractometer. This intensity ratio is therefore generally determined by placing the specimen in n different positions and finding a mean of the n intensity ratios thus obtained.

The X-ray diffractometry measurements described above, averaged over the number of test specimens used, are shown in Table 1.

### EXAMPLE 2

After the step of cooling to environmental temperature as mentioned above, the EFI test specimens, produced as stated in Example 1, were reheated to a temperature of 195° C. and were held at this temperature for a period of approximately 1 hour.

This heating step was introduced to eliminate any orientation caused in the material by the moulding process.

In a similar way to that described in Example 1, dielectric strength and X-ray diffractometric measurements were carried out on the EFI test specimens produced in this way. The results of these tests are shown in Table 1.

TABLE 1

| | INTENSITY RATIO OF | MEAN DIELECTRIC |
|---|---|---|
| | THE PEAKS WITH | STRENGTH |
| TEST SPECIMENS | INDICES 110 AND 040 | (kV/mm) |
| Example 1 | 0.5 | 190 |
| Example 2 | 3 | 120 |

On the basis of the experimental tests described above, the Applicant has found that an increase of the orientation of the polymeric material of the test specimens (in other words a decrease in the aforesaid intensity ratio) is accompanied by a considerable increase in the value of dielectric strength of the material.

This is because this tendency was confirmed by the values shown in Table 1, from which it was possible to demonstrate that an oriented material (Example 1: intensity ratio of 0.5) had a dielectric strength (Example 1: dielectric strength of 190 kV/mm) considerably higher than that (Example 2: dielectric strength of 120 kV/mm) possessed by a similar non-oriented material (Example 1: intensity ratio of 3).

Further analyses carried out by the Applicant on EFI test specimens made from material other than Rexflex® WL 105 (used in Examples 1 and 2) confirmed the aforesaid tendency.

For example, similar results were obtained by the Applicant when the Hifax® KS 081 product made by Montell S.p.A. was used as the polymeric thermoplastic material. This is a heterophasic copolymer of propylene, having an ethylene/propylene elastomeric phase content of approximately 65% by weight (with 72% propylene by weight in the elastomericic phase), a melting enthalpy of 32 J/g, a melting point of the polypropylene phase of 163° C., a MFI of 0.8 dg/min and a bending modulus of approximately 70 MPa. This material, moulded at a temperature of 166° C. in a similar way to that described in Example 1, showed an oriented structure corresponding to a dielectric strength value of 170 kV/mm. This moulding step was carried out in the proximity of its melting point at approximately 165° C. (measured by differential scanning calorimetry (DSC), a temperature corresponding to the peak of the isotactic polypropylene portion (PP) present in the PP/EPR reactor heterophasic mixture described above).

### EXAMPLE 3

A prototype cable for medium voltage was then produced: this was of the type illustrated in FIG. 1, in which the insulating coating of thermoplastic polymeric material was oriented directly during the extrusion step according to the present invention.

The production line for this cable, as described in detail above, comprised an extruding machine with a triple head, in other words three separate extruders opening into a single extrusion head to provide the co-extrusion of the semiconductive coatings and of the insulating coating to form the aforesaid cable core.

Therefore, a Cu/Sn conductor (consisting of a plurality of wires stranded together to form a cross section of 70 mm²) was coated on the extrusion line with an inner semiconductive coating having a thickness of 0.5 mm. The composition of the semiconductive coating, prepared by means of an 8-liter Banbury mixer with a volume filling factor of approximately 75%, comprised:

| Hifax ® KS 081 | 100 phr |
|---|---|
| Black Y-200 | 55 phr |
| Anox ® 20 | 0.2 phr |
| Irganox ® PS 802 | 0.4 |

where:

Black Y-200 is acetylene carbon black made by the SN2A company, with a specific surface of 70 m²/g;

Anox® 20 is an antioxidant of the phenol type, more specifically tetrakis [3-(3,5-dibutyl-4-hydroxyphenyl) propionyloxymethyl] methane made by the Great Lakes company;

Irganox® PS 802 is distearyl thiopropionate (DSTDP) (an antioxidant made by Ciba Geigy).

The term “phr” denotes parts by weight per 100 parts by weight of rubber.

Said inner semiconductive coating was deposited by means of a 45 mm single-screw Bandera extruder, in the 20 D configuration, provided with three zones of heat regulation by using diathermic oil. The thermal profile of said extruder is shown in Table 2.

An insulating layer of Rexflex® WL 105 with a thickness of 5.5 mm was extruded on top of said inner semiconductive coating. Said insulating layer was deposited by means of a 100 mm single-screw Bandera extruder, in the 25 D configuration, provided with a thermal profile as shown in Table 2. The extruder of the insulating coating had a greater number of zones of heat regulation (carried out by means of diathermic oil) than the extruder of the inner semiconductive layer, since the extruder of the insulating layer had a greater length. The aforesaid thermal profile was designed in such a way that the temperature of the insulation material in the melted state, on exit from the extrusion head, was 173° C., a temperature 14° C. higher than the melting point of said material.

An outer semiconductive coating, with a thickness of 0.5 mm and a composition identical to that of the inner semiconductive coating, as stated above, was then extruded into a position radially external to said insulating coating. Said outer semiconductive coating was deposited by means of a 60 mm single-screw Bandera extruder, in the 20 D configuration, provided with four zones of heat regulation by using diathermic oil. The thermal profile of said extruder is shown in Table 2.

The extrusion line had a speed of 1 m/min.

TABLE 2

| | Extruder of | Extruder of | Extruder of |
|---|---|---|---|
| | the inner | the | the outer |
| Zone of the | semiconductive | insulating | semiconductive |
| extruder | coating (° C.) | coating(° C.) | coating (° C.) |
| Zone 1 | 170 | 150 | 160 |
| Zone 2 | 180 | 170 | 170 |
| Zone 3 | 190 | 170 | 180 |
| Zone 4 | | 170 | 190 |
| Zone 5 | | 165 | |
| Extruder | | 165 | |
| flange/head | | | |
| Head | | 165 | |

The cable produced in this way was subjected to the following tests.

Measurement of the Intensity Ratio of the Peaks with indices 110 and 040

The aforesaid cable was cut in such a way as to expose its insulating coating. A plurality of specimens with dimensions 20×40×0.5 mm were taken from this coating at different distances from the conductor. Said specimens were then subjected to X-ray diffractometric analysis as described in Example 1. The results of this analysis are shown in Table 4.

Measurement of the Partial Electrical Discharges

A measurement of partial electrical discharges according to the IEC 60502-2 standard (Section 18.1.3) was then made on the cable produced in this way to determine the integrity of the insulating coating and its interface with the inner semiconductive layer (in respect of the presence of separations, voids, defects). The results of this measurement are shown in Table 4.

Measurement of Dielectric Strength

Five portions were taken from the cable produced as shown above, each portion having a useful length of 5 m. Said portions were subjected to a dielectric strength test with alternating voltage at industrial frequency, at environmental temperature. An initial voltage (of 80 kV) was applied between the conductor and the metallic screen connected to earth, for a period of 10 minutes, and was gradually increased by 10 kV every 10 minutes until the insulating coating was perforated. The results of this test are shown in Table 4.

### EXAMPLE 4 (COMPARATIVE)

A prototype cable for medium voltage, of the type illustrated in FIG. 1, was produced in a similar way to that described in Example 3.

The production line used was similar to that of Example 3, and was capable of producing by coextrusion the semiconductive coatings and the insulating coating described above (the thicknesses of the coatings and the materials used were identical to those of Example 3).

The thermal profiles of the extruders of the respective coatings are shown in Table 3.

In this comparative example, the thermal profile imparted to the insulating coating was markedly higher, when the same material was used, than the corresponding thermal profile used in Example 3.

As a result, the temperature of the insulating material in the melted state, at the outlet of the extrusion head, was 190° C., a temperature 31° C. higher than the melting point of said material.

TABLE 3

| | Extruder of | Extruder of | Extruder of |
|---|---|---|---|
| | the inner | the | the Outer |
| | semiconductive | insulating | semiconductive |
| Extruder Zone | coating (° C.) | coating | coating (° C.) |
| Zone 1 | 180 | 145 | 170 |
| Zone 2 | 190 | 170 | 180 |
| Zone 3 | 200 | 175 | 190 |
| Zone 4 | | 180 | 200 |
| Zone 5 | | 185 | |
| Extruder | | 190 | |
| flange/head | | | |
| Head | | 190 | |

The cable produced in this way was subjected to measurements of the intensity ratio of the 110 and 040 peaks, of partial electrical discharges and of dielectrical strength, in a similar way to that described with reference to Example 3. The results of these tests are shown in Table 4.

TABLE 4

| | Ratio of | | |
|---|---|---|---|
| | intensity of | Mean | Partial |
| | peaks with | dielectric | electrical |
| | indices 110 | strength | discharges |
| Type of cable | and 040 | (kV/mm) | (pC) |
| Example 3 | 0.7 | 48 | <5 |
| Example 4 | 2.3 | 25 | <5 |

These results showed that, in the case of a real cable (as opposed to one simulated by EFI test specimens as in Examples 1 and 2) the thermal profile imparted during the extrusion process was capable of orienting the insulating coating and imparting to the latter a value of dielectric strength greater than that of a non-oriented insulating coating.

The Applicant has also found that it is possible to increase the orientation of the thermoplastic polymeric material of said insulating coating by increasing the length of the extrusion duct.

In detail, the Applicant has found that by providing the aforesaid second intermediate die 33 with an extension 24, positioned coaxially with respect to said conductor element 2 and having an essentially cylindrical shape in its longitudinal section, said extension 24 carries out the function of subjecting the material to a shear stress throughout the period of time corresponding to the passage through said extension. This aspect is particularly advantageous since it permits an improvement of the orientation of the polymeric material described above. In Example 3, according to the invention, this extension 24 had a length of 35 mm. Preferably, this extension has a length of at least 4 times the thickness of the insulating layer which is to be extruded. More preferably, this extension has a length of more than 20 mm.

The process according to the invention has a number of advantages.

First of all, the process according to the invention makes it possible to produce a cable provided with at least one oriented thermoplastic polymeric coating with improved electrical properties (particularly in terms of dielectric strength), while maintaining, for the same mechanical properties, all the advantages associated with the use of a non-cross-linked thermoplastic material, namely recyclability of the material (and consequently of the cable at the end of its life) and simplification of the production process (the plant is less complex in its construction and is simpler to be operated).

This process, when compared with the orientation processes of the known art, also has the undoubted advantage of not requiring any additional step of stretching the polymeric material to produce its orientation. This is because, in the process according to the invention, said orientation is induced in the thermoplastic polymeric material directly during the step of its extrusion, the temperature parameter being set appropriately within the extruding machine.

As mentioned above, it should also be emphasized that this process can be applied advantageously to the production of any kind of polymeric coating, for an electrical device in general, or for a cable of a different type, for example a medium, high or low voltage cable, a telecommunications or data transmission cable, or a combined power and telecommunications cable.

1. Process for producing a cable (10) for medium or high voltage electrical power transmission or distribution, said cable (10) comprising at least one conductor (2) and at least one coating (3, 4, 5) of thermoplastic polymeric material comprising a homopolymer of polypropylene or a copolymer of propylene and of an olefinic comonomer chosen from ethylene and α-olefins other than propylene, said process comprising the steps of:
feeding said at least one conductor (2) to an extruding machine;
extruding said at least one coating (3, 4, 5) in a position radially external to said at least one conductor (2),
characterized in that said extrusion step comprises the step of orienting said at least one coating (3, 4, 5).

2. Process according to claim 1, characterized in that the orientation step comprises the step of setting the temperature of the material forming said at least one coating (3, 4, 5), at the outlet of said extruding machine, at a level exceeding the melting point of said material of not more than 20° C.

3. Process according to claim 2, characterized in that said outlet temperature is set at a value exceeding the melting point of said material of not more than 15° C.

4. Process according to claim 3, characterized in that said outlet temperature is set at a value exceeding the melting point of said material of not more than 10° C.

5. Process according to any one of the preceding claims, characterized in that said process comprises the step of cooling said at least one coating (3, 4, 5) at the outlet of said extruding machine.

6. Process according to claim 5, characterized in that, after the extrusion and cooling steps, said material forming said at least one coating (3, 4, 5) has an intensity ratio of not more than 1 between the diffractometric peaks with indices 110 and 040.

7. Process according to any one of the preceding claims, characterized in that said at least one coating (3, 4, 5) is extruded in at least one die (33) provided with an extension (24) having a length at least equal to four times the thickness of said at least one coating (3, 4, 5).

8. Process according to claim 7, characterized in that said extension (24) has a length of at least 20 mm.

9. Cable (10) comprising at least one conductor (2) and at least one coating (3, 4, 5) extruded from a thermoplastic polymeric material, said material comprising a homopolymer of propylene or a copolymer of propylene with an olefinic comonomer chosen from ethylene and (α-olefins other than propylene, said at least one coating (3, 4, 5) having a thickness of not less than 2.5 mm, characterized in that said at least one coating (3, 4, 5) has an intensity ratio of not more than 1 between the diffractometric peaks with indices 110 and 040.

10. Cable (10) according to claim 9, characterized in that said at least one coating (3, 4, 5) has a dielectric strength greater than 30 kV/mm.

11. Cable (10) according to claim 9 or 10, characterized in that said at least one coating is the insulating coating (4) of said cable (10).

12. Cable (10) according to any one of claims 9 to 11, characterized in that said homopolymer or copolymer has a melting point above 140° C.

13. Cable (10) according to claim 12, characterized in that said homopolymer or copolymer has a melting point in the range from 145° C. to 170° C.

14. Cable (10) according to any one of claims 9 to 13, characterized in that said homopolymer or copolymer has a melting enthalpy in the range from 30 to 100 J/g.

15. Cable (10) according to claim 14, characterized in that said homopolymer or copolymer has a melting enthalpy in the range from 30 to 85 J/g.

16. Cable (10) according to any one of claims 9 to 15, characterized in that said homopolymer or copolymer has a bending modulus (measured at environmental temperature according to the ASTM D790 standard) in the range from 30 to 1400 MPa.

17. Cable (10) according to claim 16, characterized in that said homopolymer or copolymer has a bending modulus in the range from 60 to 1000 MPa.

18. Cable (10) according to any one of claims 9 to 17, characterized in that said homopolymer or copolymer has a Melt Flow Index (measured at 230° C., with a load of 21.6 N according to the ASTM D1238/L standard) in the range from 0.01 to 10 dg/min.

19. Cable (10) according to claim 18, characterized in that said Melt Flow Index is in the range from 0.1 to 5 dg/min.

20. Cable (10) according to claim 19, characterized in that said Melt Flow Index is in the range from 0.2 to 3 dg/min.

21. Method for increasing the dielectric strength of at least one coating (3, 4, 5) placed in a position radially external to at least one conductor (2) of a cable (10), at least one coating (3, 4, 5) being made from a thermoplastic polymeric material comprising a homopolymer of propylene or a copolymer of propylene with an olefinic comonomer chosen from ethylene and α-olefins other than propylene, characterized in that said thermoplastic polymeric material is oriented during the extrusion step of said at least one coating (3, 4, 5).
